(19) United States
(12) Patent Application Publication
(10) Pub. No.: US 2004/0041921 A1
(43) Pub. Date: Mar. 4, 2004

(54) Voice recognition for file naming in digital camera equipment

(75) Inventor: Keven D. Coates, Cypress, TX (US)

Correspondence Address: TEXAS INSTRUMENTS INCORPORATED, P O BOX 655474, M/S 3999, DALLAS, TX, 75265

(73) Assignee: Texas Instruments Incorporated, Dallas, TX

(21) Appl. No.: 10/230,486

(22) Filed: Aug. 29, 2002

(51) Int. Cl. H04N 5/76

(52) U.S. Cl. 348/231.2

(57) ABSTRACT

The specification discloses a method and related system for naming files in which digital images are kept in digital camera equipment. More particularly, the specification discloses that file names for images and video captured by digital camera equipment are assigned by the user by speaking the file name into a microphone of the digital camera. A digital signal processor within the camera reads the spoken file name, and using voice recognition software, converts the spoken word or words into corresponding word or words within the system. The captured image or images are then saved using the file name assigned by the user.

### CROSS-REFERENCE TO RELATED APPLICATIONS

None.

### STATEMENT REGARDING FEDERALLY SPONSORED RESEARCH OR DEVELOPMENT

Not applicable.

### BACKGROUND OF THE INVENTION

1. Field of the Invention

The preferred embodiments of the present invention are directed generally to digital cameras. More particularly, the preferred embodiments are directed to file naming for storage of pictures in digital cameras and digital video equipment. More particularly still, the preferred embodiments are directed to using voice recognition for file naming in digital cameras and digital video equipment.

2. Background of the Invention

Digital still picture cameras, and digital video cameras (sometimes embodied in the same device) are becoming increasingly popular with consumers. Generally speaking, a digital camera comprises a charge couple device (CCD) array or CMOS sensor array coupled to a non-volatile storage media through a digital signal processor (DSP). Whether the camera is capturing individual images as pictures, or taking a series of images to produce video, in related art devices the digital camera typically assigns a file name to the file containing the picture or pictures without input from the user. For example, a first picture stored in an exemplary Sony Cyber-Shot® digital camera may be assigned a file name “DSC001” A second picture taken and stored by the user is assigned a file name “DSC002,” and so on. In cases where a consumer has purchased a digital video camera having a significant amount of memory, or has inserted memory sticks into the digital camera, that camera may be capable of storing hundreds of digital pictures. In these circumstances, when the user attempts to download and view a particular picture stored, the file names are not at all indicative of the contents of each of the pictures.

Thus, what is needed in the art is a mechanism whereby a user of a digital camera can quickly and easily name a file for which a picture or video may be stored.

### BRIEF SUMMARY OF SOME OF THE PREFERRED EMBODIMENTS

The problems noted above are solved in large part by a digital camera that allows the user to name the files where the images are stored. More particularly, the preferred embodiments are directed to a digital video camera or digital still camera having a microphone and voice recognition software running on some form of microprocessor within the camera. After a consumer or user takes the picture and confirms that the picture should be saved, preferably the consumer speaks a file name into the microphone. The voice recognition software of the preferred embodiments converts the spoken words to a file name, and the camera then saves the picture or video in a file having that file name. In this way, when later transferring the images (or video images) from the camera, the user knows generally the contents of the picture or video based on the file name.

The disclosed devices and methods comprise a combination of features and advantages which enable it to overcome the deficiencies of the prior art devices. The various characteristics described above, as well as other features, will be readily apparent to those skilled in the art upon reading the following detailed description, and by referring to the accompanying drawings.

### BREIF DESCRIPTION OF THE DRAWINGS

For a detailed description of the preferred embodiments of the invention, reference will now be made to the accompanying drawings in which:

FIG. 1 shows a digital camera of the preferred embodiment; and

FIG. 2 shows a flow diagram of operation of the digital camera of the preferred embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function.

In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct electrical connection. Thus, if a first device couples to a second device, that connection may be through a direct electrical connection, or through an indirect electrical connection via other devices and connections.

### DETAILED DESCRIPTION OF THE PREFERRED EMBODIMENTS

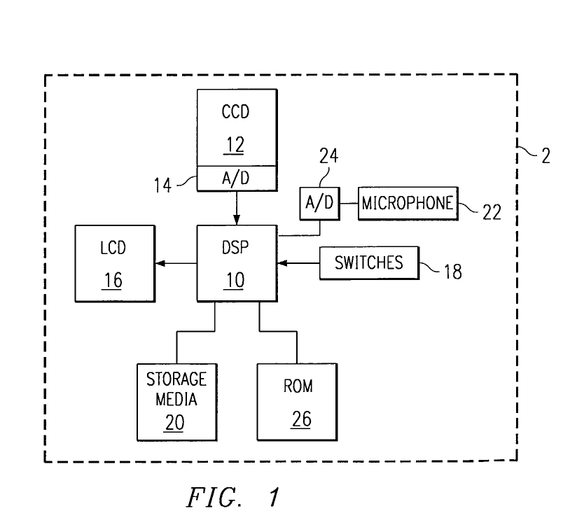

FIG. 1 shows a block diagram of a digital camera 2 of the preferred embodiments. The heart of the digital camera of the preferred embodiments is a digital signal processor (DSP 10), which is a microprocessor specially adapted for performing mathematical operations, such as those for image processing. In the preferred embodiments, the DSP 10 is a TMS320DSC21 digital signal processor produced by Texas Instruments, Inc.; however, many equivalent digital signal processors exist on the market and may be used. Further, it would be possible to implement a digital camera using a microprocessor adapted for mobile operation, and this too is within the contemplation of this invention. The DSP 10 preferably couples to a charge couple device (CCD) array 12, or may equivalently couple to a CMOS array. The array 12 is responsible for detecting lightwaves, and in essence, capturing the image from the field. Although the array 12 is shown only as a single block in FIG. 1, one of ordinary skill in the art understands that either a single array in combination with a red, green and blue filters, may be used, or a digital camera may use three arrays positioned downstream of a beam splitting device.

Each pixel of the array 12, after exposure to an image, holds an electric charge which is proportional to the intensity of the light received. Stated otherwise, each pixel contains an analog value representing the intensity; however, the digital signal processor 10 performs its operations on digital data, and therefore the preferred embodiments also comprise an analog-to-digital converter 14 coupled between the array 12 and the DSP 10. As implied by the drawing of FIG. 1, most camera quality arrays have an integrated analog-to-digital converter, such as analog-to-digital converter 14. It is an equivalent implementation, however, that the analog-to-digital converter 14 could be a stand-alone device coupled between the array 12 and the DSP 10, or that the DSP 10 could have an on-board analog-to-digital converter to perform this function.

As is common for digital cameras, in the preferred digital camera the user aligns the shot by viewing a liquid crystal display (LCD) 16. Thus, even if the digital camera is not in the process of recording an image, the DSP 16 reads the images in the field of view of the array 12 and displays those on the LCD 16. Once the user aligns the image in the LCD display 16, the user informs the digital camera that he or she wishes to capture and store an image by actuation of one or more switches 18. The switches 18 couple to the DSP 10 by way of digital inputs (not specifically shown) of the DSP 10. Upon command by one of the switches 18, the DSP 10 acquires the image from the array 12 and, if the user wishes to save the captured image, the digital camera stores the image as a file in the storage media 20, such as in a “JPEG” or “TIF” format. The storage media 20 may be any suitable long-term storage device such as compactFlash memory, smart media or memory sticks. In the preferred embodiments, the user is given the option to create or externally supply a file name for the image captured.

In the preferred embodiments, assigning a user-created file name to a captured image involves the user speaking a file name into a microphone 22. The microphone 22 may be of any suitable technology, such as those used in cellular telephones, wireless telephones, computer microphones, and the like. Further, the microphone 22 may be integrated within the digital camera 2, which is preferred, or the microphone may be separate from, yet coupled to, the digital camera. The DSP 10 preferably reads the time varying analog signal created by the user speaking into the microphone through an analog-to-digital converter 24. While FIG. 1 shows the preferred implementation of the analog-to-digital converter 24 being an independent component within the digital camera, it is within the contemplation of this invention that the analog-to-digital converter could be integrated within the DSP 10. After receiving the spoken words of the user representing the desired file name, the DSP 10 preferably executes voice recognition software which converts the digital representation of the spoken words of the desired file name into the file name for the image captured.

More particularly, the digital camera of the preferred embodiments comprises read-only memory (ROM) coupled to the digital signal processor by an appropriate bus structure. The ROM 26 of the preferred embodiments stores a voice recognition program which is executed by the digital signal processor when ascertaining the file name spoken by the user. There are many voice recognition software packages available on the market, which at an underlying basis, would be capable of performing the function of converting the spoken word of the user into a file name. For example, Dragon Naturally Speaking™ is a commercially available voice recognition software system whose underlying voice recognition algorithms could be modified for use in a digital camera. It is noted that precise voice recognition need not necessarily be used. In fact, it is within the contemplation of this invention that the voice recognition system utilized could have a significantly limited database of words, or possibly may be only responsible for phonetically spelling the file names Although it would be an operable for the digital camera user to speak single words as file names, in the preferred embodiments, the file names conform to the File Allocation Table (FAT) 32 file-naming convention, meaning that up to 256 characters may be used for a file name. Given potential file names of this length, in the preferred embodiments, the user may speak a short group of words to identify the file name. For example, the file names could be as simple as “boat,” “house,” “wife,” or could be more descriptive such as “big fish,” or “sunset_over_the_lake.”

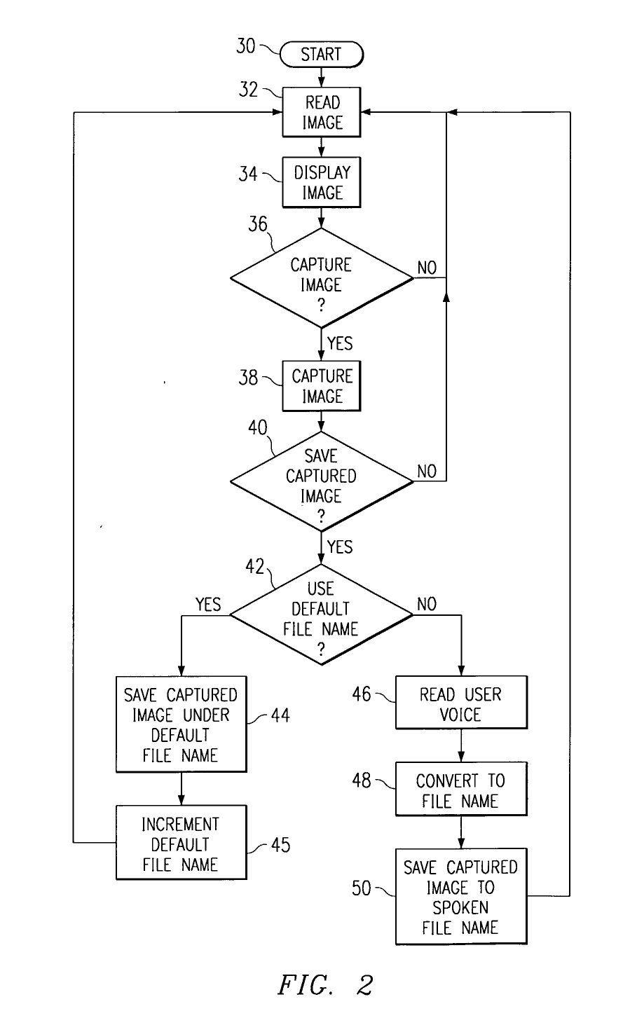

FIG. 2 shows a flow diagram of operation of the digital camera 2 of the preferred embodiments. In particular, the process starts at block 30, with the camera in a powered-down condition (step 30) and proceeds to an image alignment mode that comprises repeatedly reading an image (step 32), displaying the image (step 34) or the LCD device 16 (FIG. 1) and determining whether the user has pressed one of the switches 18 (step 36). It is within these series of steps that the camera of the preferred embodiments rotates through during a time when the user is aligning a photographic shot prior to capturing the image. Once the user presses the appropriate switch 18, the image is captured (step 36) and the user is prompted as to whether that particular image should be saved (step 40). If the user elects not to save the captured image, the process retreats to blocks 32-36, where the image is continuously read and displayed on the LCD device 16. If, however, the user elects to save the captured image (block 40), the user is then prompted as to whether to save the captured image under a default or internally supplied file name, or to save the image under an externally supplied file name (step 42). If the user elects to save the image under a default file name (for example the digital camera is being used to take pictures in rapid succession where the user does not have time to assign a name, or where ambient noise is too great to allow assignment of a file name as in the preferred embodiments) the captured image is saved under the default file name (step 44). Thereafter, the default name is incremented (step 45) and the process again resumes continuously reading and displaying images on the LCD display for alignment of the next shot (steps 32-36).

If, and as is preferred, the user chooses to assign a file name to the captured image, the digital camera 2 reads the user's voice (step 46) and converts the voice using voice recognition software into a file name (step 48). Once the user's spoken voice is converted to a file name, the captured image is saved to the storage media 20 using that converted file name (step 50), and the process transitions to the continuous capture and display of images for alignment of the next shot (steps 32-36).

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method of operating a digital camera comprising converting a word spoken into a microphone coupled to the digital camera into a file name for storage of an image captured by the digital camera.

2. The method as defined in claim 1 wherein converting a word spoken into a microphone of the digital camera into a file name further comprises executing voice recognition software on the digital camera that converts the word spoken into the microphone into the file name.

3. The method as defined in claim 2 wherein executing voice recognition software on the digital camera further comprises executing voice recognition software on a digital signal processor within the digital camera.

4. The method as defined in claim 3 wherein executing voice recognition software on a digital signal processor within the digital camera further comprises executing the voice recognition software on a part number TMS320DSC21 digital signal processor produced by Texas Instruments, Inc.

5. The method as defined in claim 1 further comprising:
capturing an image to create the captured image;
prompting the user to one of accept or reject the captured image, and if the image is accepted;
allowing the user to choose one: i) of using an assigned file name for storage of the captured image, and ii) converting a word spoken into a microphone of the digital camera into a file name for storage of an image captured by the digital camera.

6. The method as defined in claim 5 wherein capturing an image to create the captured image further comprises capturing a series of images to create a captured video image.

7. The method as defined in claim 1 further comprising converting a plurality of words spoken into a microphone of the digital camera into a file name for storage of an image captured by the digital camera.

8. The method as defined in claim 7 further comprising limiting a length of the file name to 256 characters.

9. The method as defined in claim 1 further comprising converting the word spoken into an integral microphone of the digital camera into a file name for storage of an image captured by the digital camera.

10. A digital camera having the ability to convert a word spoken into a microphone coupled to the digital camera into a file name in which a picture taken by the digital camera is stored.

11. The digital camera as defined in claim 10 further comprising a digital signal processor, and wherein the digital signal processor executes voice recognition software to convert the word spoken into the microphone into the file name in which picture is stored.

12. The digital camera as defined in claim 11 wherein the digital signal processor further comprises a part number TMS320DSC21 digital signal processor produced by Texas Instruments, Inc.

13. The digital camera as defined in claim 11 further comprising an analog to digital converter coupled between the microphone and the digital signal processor, and wherein the analog to digital converter converts an analog signal created by the microphone into a digital signal.

14. A digital cameral comprising:
an array that records light intensity;
a storage media;
a digital signal processor (DSP) coupling the array to the storage media;
a microphone coupled to the DSP; and
wherein the digital camera is adapted to convert a word spoken into the microphone to a file name for storage of an image captured by the digital camera.

15. The digital camera as defined in claim 14 wherein the digital camera is further adapted to convert a plurality of words spoken into the microphone into the file name for storage of the image captured.

16. The digital camera as defined in claim 15 wherein the file name is limited to 256 characters.

17. The digital camera as defined in claim 14 wherein the digital signal processor is further adapted to execute voice recognition software to convert the word spoken into the microphone to the file name.

18. The digital camera as defined in claim 14 wherein the DSP further comprises a part number TMS320DSC21 digital signal processor produced by Texas Instruments, Inc.

19. The digital camera as defined in claim 14 further comprising an analog-to-digital converter coupled between the DSP and the microphone.

20. The digital camera as defined in claim 19 wherein the analog-to-digital converter is integrated with the DSP.

21. A method of operating a digital camera, comprising:
capturing an image with the digital camera;
supplying a file name externally from the digital camera; and
storing the captured image under the file name.

22. The method as defined in claim 21 wherein supplying a file name externally from the digital camera speaking a word into a microphone coupled to the digital camera.

23. The method as defined in claim 22 further comprising speaking a plurality of words into the microphone.

24. The method as defined in claim 23 further comprising limiting a length of the file name to 256 characters.

25. The method as defined in claim 22 further comprising:
creating an analog representation of the word spoken;
changing the analog representation of the word spoken to a digital representation;
converting the digital representation of the spoken word into a file name using voice recognition software.

26. The method as defined in claim 25 wherein converting the digital representation of the spoken word into a file name using voice recognition software further comprises executing the voice recognition software on a microprocessor in the digital camera.

27. The method as defined in claim 26 wherein executing the voice recognition software on a microprocessor further comprises executing the voice recognition software on a digital signal processor.
